(19) United States
(12) Patent Application Publication
(10) Pub. No.: US 2007/0199577 A1
(43) Pub. Date: Aug. 30, 2007

(54) Method And Device For Removing Liquids From The Surface Of A Strip

(75) Inventors: Gert Mucke, Hilden (DE); Gunther Coen, Velbert (DE); Frank Gorgels, Aachen (DE)

Correspondence Address: HENRY M FEIEREISEN, LLC, 350 FIFTH AVENUE, SUITE 4714, NEW YORK, NY, 10118, US

(73) Assignee: Betriebsforchungsinstitut Vdeh-Institut fur Angewandte Forschung Gmbh, Dusseldorf (DE)

(21) Appl. No.: 10/599,613

(22) PCT Filed: Mar. 11, 2005
(86) PCT No.: PCT/EP05/02648

§ 371 Date: Oct. 3, 2006

(30) Foreign Application Priority Data
Apr. 5, 2004 (DE) 10 2004 017 216.1
Jul. 30, 2004 (DE) 10 2004 037 396.5

(51) Int. Cl. B08B 3/00; B08B 3/12; B08B 6/00

(52) U.S. Cl. 134/1; 134/34; 134/184

(57) ABSTRACT

A method for removing liquids from the surface of a strip, characterized in that the liquid is excited in such a way that it oscillates. The invention is based on the recognition that the root of the problem of removing liquids from the surface of a strip lies in the adhesion forces and that these adhesion forces can be overcome by exciting the liquid in such a way that it oscillates. Its oscillation causes the liquid to detach itself from the surface of the strip and it can then be easily carried away, for example by suction by means of low pressure, blowing or stripping by means of a stripper.

### BACKGROUND OF THE INVENTION

The invention relates to a method and a device for removing liquids from the surface of a moving strip. Methods and devices of this type are used in particular in the case of strip processing machines, such as roiling stands for example.

In strip processing processes, it is customary to apply lubricants to the strip, in order for example to assist the deforming process during the rolling operation and in order to dissipate deformation heat and fragments of strip. Remains of these lubricants stay attached to the strip after the rolling operation as residues. If these remains are not removed before the strip is formed into a coil, they form a lubricating film between the individual turns, possibly leading to undesired displacement of the individual turns in the axial direction of the coil. Furthermore, only very small remains of the liquids previously used may be present on the surface of the strip for the further treatment of the strips.

At present, the liquids are removed from the surface of the strip by one of the following measures: squeezing by metal, rubber, plastic or nonwoven rollers, stripping with the aid of strippers in a form such as a rubber lip, blowing with the aid of an air stream and sucking with the aid of low pressure. The running speed of the strip thereby often restricts the manner of removal of the lubricant remains. The strips are run at the lowest possible speeds in order to remove as much liquid as possible by remaining longer in the device for removing liquids.

DE 195 19 544 C2 describes for example a device in which a gas jet is blown onto the strip for cleaning the strip surface. The gas is directed onto the strip with a high flow velocity. The aim is to transport the amounts of liquid away from the surface of the strip to be cleaned by means of a mass pulse. EP 0 513 632 B1 describes a similar device, in which the gas jet has an exit velocity on leaving the nozzle of 0.3 to 2 Mach and is blown onto the surface of the strip at an angle of 45 to 90°. Devices of this type are very energy-intensive. The high flow velocities also lead to the problem of a high noise level.

### SUMMARY OF THE INVENTION

Against this background, the invention is based on the object of proposing a method and a device for removing liquids from the surface of a moving strip which permit efficient removal of the liquid by simple means.

This object is achieved by the independent claims. Advantageous refinements are presented in the subclaims.

The invention is based on the recognition that the root of the problem of removing liquids from the surface of a strip lies in the adhesion forces and that these adhesion forces can be overcome by exciting the liquid in such a way that it oscillates. Its oscillation causes the liquid to detach itself from the surface of the strip and it can then be easily carried away, for example by suction by means of low pressure, blowing or stripping by means of a stripper. For the techniques of removing the liquid that is detached from the surface, the invention can consequently resort to the techniques known from the prior art. The basic concept of the invention is to excite the liquid in order thereby to facilitate further steps for removing the liquid. Depending on the manner of excitation, it is even possible to dispense with subsequent steps, for example if the excitation is performed on the principle of sonoluminescence.

The excitation of the liquid is preferably performed in such a way that contiguous areas of liquid, for example a liquid film, are completely excited to undergo oscillation. In this case, the excitation and the further treatment of the film, for example removal in the manner of blowing/suction in a preferably laminar flow, can be performed in such a way that the liquid film is preserved, or at least only divided into large parts, for example parts with an extent of at least twice the film thickness, with particular preference parts with a much greater extent, such as for example 3 to at least 10 times the film thickness. In a preferred embodiment, an excitation which prevents the formation of liquid aerosols is set. This allows the effect to be achieved that the liquid removed by suction or blowing, for example in the form of parts of a large area or spherical parts can be easily recovered. As a result, the advantage that is made possible by the method according to the invention even other than within this preferred embodiment, that of the recovery of expensive liquids, for example oils in rolling mills, is achieved particularly easily.

This invention is used in particular for the removal of liquids from moving strips, and here in particular in rolling trains. The basic concept according to the invention can also be applied, however, to stationary strip surfaces. The liquid to be removed is, in particular, an oil or an emulsion which has been applied to the strip during the rolling operation as a coolant and/or lubricant. The invention is used with particular preference for detaching liquid films which take up virtually the full width of the strip, since the method according to the invention is suitable for detaching these large-area liquid films efficiently from the strip.

The invention is used particularly well in the case of film strips to be detached of at least 1.5 μm. and can also be used very advantageously in the case of film thicknesses to be detached of 100 μm. and much more. With respect to the thickness of the film to be detached, the only limits on the invention are set by the oscillation generators that can currently be economically supplied. However, it can be expected that improvements in oscillation generator technology will also open up further areas of use for the invention. With particular preference, the liquid film is completely detached from the strip. However, partial detachment of the film, for example a reduction of the film thickness to 0.15 μm., also represents an expedient compromise made possible by the invention between expenditure on equipment and the desired result.

The excitation of the liquid is performed in particular in such a way that the liquid oscillates over a relatively long period of time, for example while it runs through the device intended to remove it.

In a preferred embodiment, the liquid is excited in such a way that it oscillates at its resonant frequency. As a result, the effect of detachment from the surface of the strip is achieved particularly well. With particular preference, a contiguous liquid, for example a film, is excited to undergo a thickness resonance. This is achieved with particular preference if the wavelength of the excitation oscillation in a carrier fluid, for example air, is 2 to 4 times the film thickness.

The oscillation of the liquid may be achieved by various methods. Firstly, an oscillating body or oscillating fluid may transfer oscillations (excitation oscillation) to the liquid and thereby excite the liquid. However, the liquid may also be excited contactlessly, indirectly by electromagnetic ultrasound generators or directly by laser-induced ultrasound.

In a preferred embodiment, the liquid is excited by a fluid stream flowing over the liquid as a carrier medium for an excitation oscillation. For this purpose, devices such as those known from EP 0 513 632 B1 or DE 195 19 544 C2 may be used, these devices being supplemented by a sound-wave generator, which introduces sound waves into the fluid stream delivered from the nozzles. Sound-wave generators of this type may for example be loudspeakers or piezoelectric materials. The fluid stream may be aligned in the direction of the strip running direction or counter to it and at an angle to the strip running direction.

In a preferred embodiment, the excitation oscillation introduced into the fluid stream propagates perpendicularly in relation to the direction of flow of the fluid stream. As a result, particularly effective excitation of the liquid by the excitation oscillation is achieved. In this case, in a preferred embodiment, the direction which the ultrasound is radiated in should be chosen such that the direction of the resultant oscillation of the fluid after superposition of the ultrasound velocity and fluid velocity is perpendicular to the direction of flow of the fluid stream.

The fluid stream preferably flows over the liquid in a laminar form. This achieves the effect that the excitation oscillation can excite the liquid well and the excitation is not impaired by superposed oscillations or pulses caused by turbulence. A laminar flow of the fluid stream also prevents the liquid film from being atomized into aerosols, which depending on the application are undesired. Devices for generating a laminar flow on a moving strip may, for example, use the aerodynamic paradox, as described in DE 199 23 949 A1, to which reference is expressly made for the method and the device for generating a fluid stream flowing over the liquid in a laminar form, and the relevant disclosure of which is understood as part of this description.

Air is used in particular as the fluid. However, the use of other gases or liquids is likewise conceivable, in particular the use of oxygen-free gases, in order to avoid oxidation of a metallic strip.

Instead of bringing about the excitation of the liquid via a free surface of the liquid, the excitation may additionally or alternatively be performed via solid bodies in contact with the liquid. In particular, the liquid is preferably excited by an oscillating motion of the strip. For this purpose, the strip is deliberately set in oscillation. This may be performed by means of elements acting directly on the strip, such as piezoelectric exciters or for example by shocks. However, the strip may also be excited contactlessly, for example by using magnetic ultrasound generators, known as EMATs (electromagnetic-acoustic transducers).

Just as the strip can be contactlessly excited to excite the liquid, the liquid itself can also be contactlessly excited, for example by laser-induced ultrasound.

In addition or alternatively, according to a further basic concept of the invention, in a method for removing liquids from the surface of a strip, the liquid may be evaporated by using the sonoluminescence effect. Sonoluminescence is understood as meaning the phenomenon that a liquid can emit ultra-short, high-energy flashes of light under great acoustic pressure. The phenomenon is caused by cavitations, which may be produced in the liquid under ultrasound of a suitable intensity. In a continuous process, new cavitations are produced and subsequently collapse again. When these cavitations collapse, a short flash of light may be produced. The temperature inside the cavitation may in this case reach several millions of degrees Celsius. These temperatures can be used to evaporate the liquid to be removed.

Additionally or alternatively, in a method for removing liquids from the surface of a strip, a laminar fluid stream may be made to pass over the liquid. Just the use of a laminar fluid stream which does not excite the liquid exhibits good entrainment of liquid particles, so that efficient removal is made possible. Devices for generating a laminar flow on a moving strip may, for example, use the aerodynamic paradox, as described in DE 199 23 949 A1, to which reference is expressly made for the method and the device for generating a fluid stream flowing over the liquid in a laminar form, and the relevant disclosure of which is understood as part of this description.

As part of a method according to the invention, a closed-loop control may be provided and used for setting the frequency at which the liquid oscillates. This is performed in particular by setting the frequency of the excitation oscillation. Input parameters for the closed-loop control may be the material properties of the liquid, of the fluid and of the strip, and also the—measured—film thickness of the liquid to be removed, the strip speed, the temperature and possibly the squeezing pressure of upstream squeezing rollers or strippers.

The flow velocity and the energy introduced by the oscillation generator and also the frequency of the wave emitted by the oscillation generator are preferably coordinated with one another. In particular, the energy introduced is preferably chosen to be great enough that the flow velocity can be set so low that a laminar flow is produced. For example, with air as the fluid, an introduced power of over 20 W/mm², in particular of over 80 W/mm², and a frequency of over 500 kHz, in particular preferably of over 1 MHz, for example 80 to 800 MHz, can be set. The flow velocity is then preferably set such that a Reynolds' number (Re) of less than 1 000 000 is achieved, in particular preferably a Re of around 2000. At the same time, with particular preference, a Mach number of less than 0.3, in particular preferably of less than 0.2, is set.

Depending on the structure of the device for carrying out the method according to the invention, the flow velocity and the energy introduced by the oscillation generator and also the frequency of the wave emitted by the oscillation generator are preferably coordinated with one another in such a way that a liquid film is divided up into parts which are carried only over a certain distance, preferably the width of the strip, by a fluid stream flowing over. This allows the effect to be achieved that the liquid is lifted off the strip, but—presupposing a corresponding direction of flow of the fluid stream—falls again from the fluid stream beyond the strip, for example in the region of the edge of the strip or, with an inwardly directed fluid stream, at a collecting point above the middle of the strip. Carrying out the method according to the invention in such a way prevents the detached liquid from getting into a suction removal system and having to be recovered there. In other embodiments, it may however be specifically advantageous for the recovery of the liquid to discharge it into the suction removal system, if the suction removal system is designed for the recovery of the liquid.

A device according to the invention for removing liquids from the surface of a strip has an oscillation generator which can excite oscillations in the liquid or in a fluid or body contacting the liquid.

The device preferably has a blowing nozzle and a sound-wave generator, which introduces sound waves into the fluid applied by the blowing nozzle. In this case, the sound-wave generator may be arranged upstream or downstream of the blowing nozzle. A blowing nozzle is in this case understood as meaning any element from which a fluid stream emerges. Additionally or alternatively, the device according to the invention may have a sound-wave generator which introduces sound waves into the strip. Similarly, the oscillation generator may be a sound-wave generator which generates oscillations directly in the liquid itself, for example a laser-induced ultrasound system.

The generated oscillation of the fluid or the excitation oscillation preferably have a frequency in the ultrasound range.

### BRIEF DESCRIPTION OF THE DRAWING

The invention is explained in more detail below on the basis of a drawing, which merely represents exemplary embodiments and in which:

FIG. 1 shows the device according to the invention in its basic structure in a schematic side view,

FIG. 2 shows the device represented in FIG. 1 in a second schematic side view,

FIG. 3 shows an embodiment of the device according to the invention in a schematic side view,

FIG. 4 shows a second embodiment of the device according to the invention in a schematic side view,

FIG. 5 shows a third embodiment of the device according to the invention in a schematic side view,

FIG. 6 shows a fourth embodiment of the device according to the invention in a schematic side view,

FIG. 7 shows the embodiment that is shown in FIG. 6 in a schematic plan view,

FIG. 8 shows a fourth embodiment of the device according to the invention in a schematic plan view,

FIG. 9 shows the device that is shown in FIG. 8 in a schematic side view,

FIG. 10 shows a sixth embodiment of the device according to the invention in a schematic side view,

FIG. 11 shows the embodiment according to FIG. 10 in a schematic plan view,

FIG. 12 shows a seventh embodiment of the device according to the invention in a schematic side view, and

FIG. 13 shows an eighth embodiment of the device according to the invention in a schematic side view.

### DETAILED DESCRIPTION OF PREFERRED EMBODIMENTS

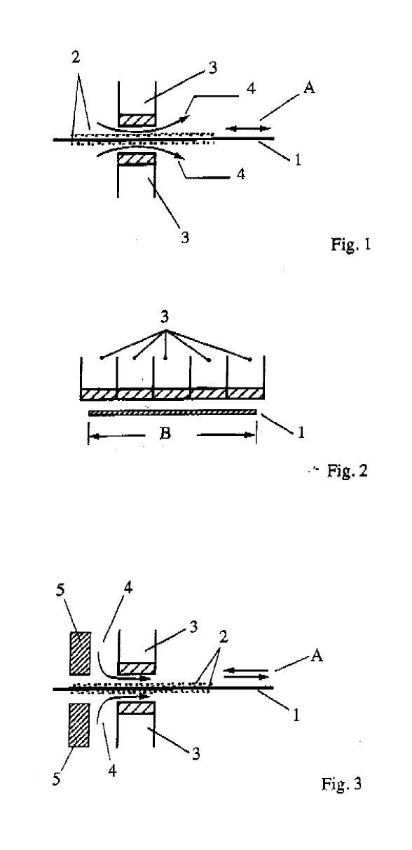

FIG. 1 shows a moving strip 1, on the upper side and underside of which a liquid 2, for example lubricant, attaches. Respectively fitted above and below the strip 1 is a transducer 3. An air stream 4 is respectively generated by blowing nozzles (not represented) between the free surface of the liquid 2 and the transducer 3. The directional arrows A indicate that the air stream 4 may be directed both with and counter to the strip running direction. FIG. 2 shows that the transducers 3 arranged above the strip 1 are arranged next to one another in such a way that transducers extend over the entire width B of the strip.

For removing the liquid 2 from the surface of the strip 1, sound waves are emitted into the air stream 4 by the transducers 3, which are formed for example as piezoelectric ultrasound-transmitting probes. As a result, the air stream 4 is excited to undergo an oscillation. The air stream 4 transfers this excitation oscillation to the liquid 2 and excites the latter to undergo an oscillation. In this case, the excitation oscillation is chosen such that it excites the liquid preferably to undergo an oscillation at the resonant frequency of the liquid. The oscillation has the effect that the liquid is moved in such a way that the adhesion forces which hold the liquid on the surface of the strip are at least partially overcome. The liquid 2 “detached” in this way is then carried away by the air stream 4 and consequently removed from the strip.

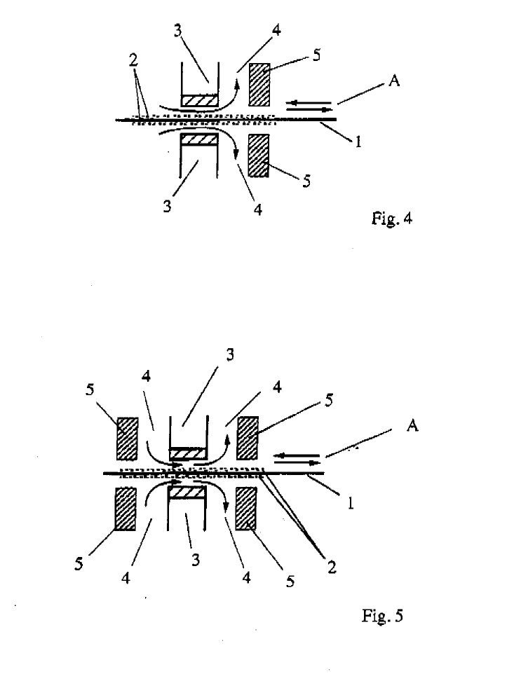

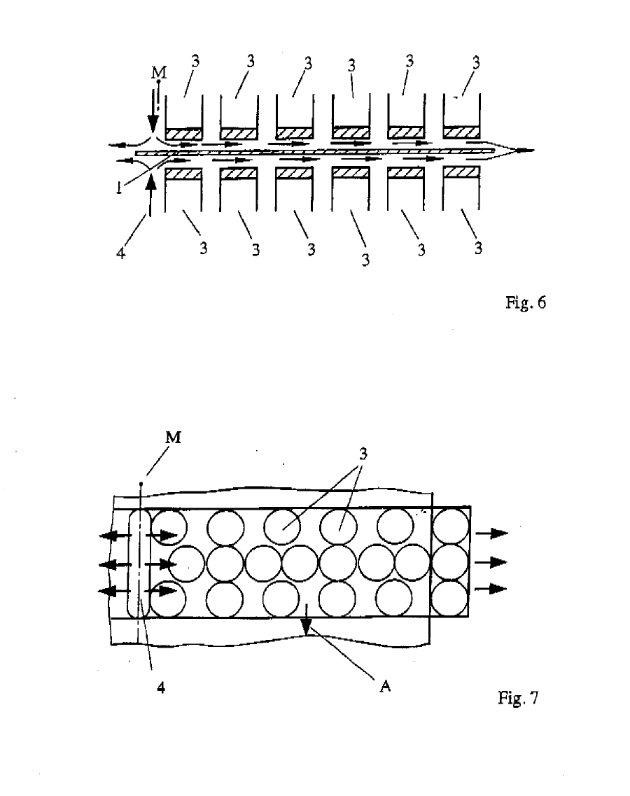

FIGS. 3 to 5 show that the air stream 4 can be deliberately directed onto the surface of the strip or away from the surface of the strip by delimiting bodies 5.

While FIGS. 1 to 5 show an air stream 4 which is directed substantially in the strip running direction or counter to the strip running direction, the air stream 4 in the embodiments of FIGS. 6 to 9 is directed perpendicularly in relation to the strip running direction. In the case of the embodiment of FIGS. 6 and 7, this is achieved by the air stream 4 being blown in the middle M of the strip, between the transducers 3 arranged symmetrically with respect to the middle M of the strip, and sucked away at the edge region of the strip.

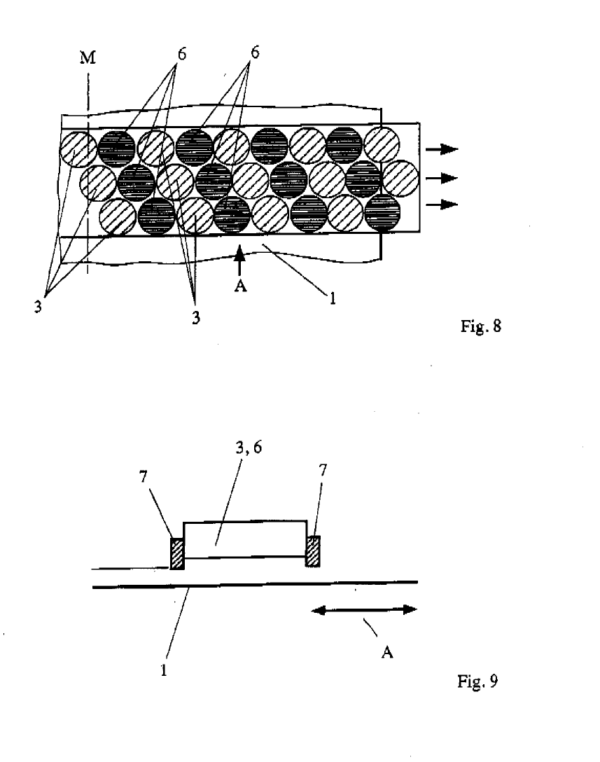

An air flow directed toward the edge of the strip can likewise be generated by the transducers 3 and the blowing nozzles 6 being arranged perpendicularly in relation to the strip running direction A alternately and as rows at an angle to the strip running direction A, as represented in FIG. 8. For better guidance of the air flow, it is possible, as represented in FIG. 9, for a sealing lip 7 to be arranged upstream and/or downstream of the group of transducers 3 and the group of blowing nozzles 6.

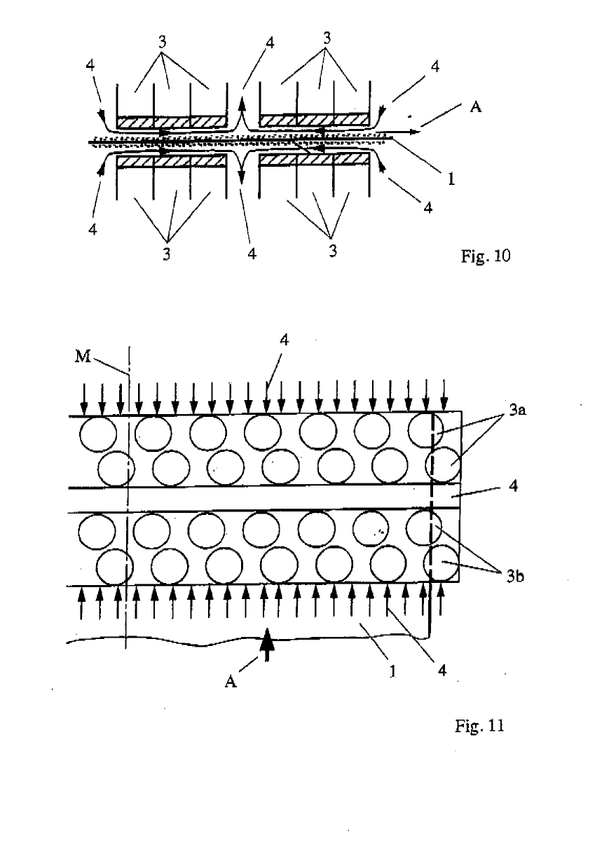

In the embodiment of FIGS. 10 and 11, two air streams 4 are fed toward each other and sucked away between two groups of transducers 3. In this case, the transducers 3a may generate an excitation oscillation at a higher frequency than the transducers 3b of FIG. 11, or vice versa.

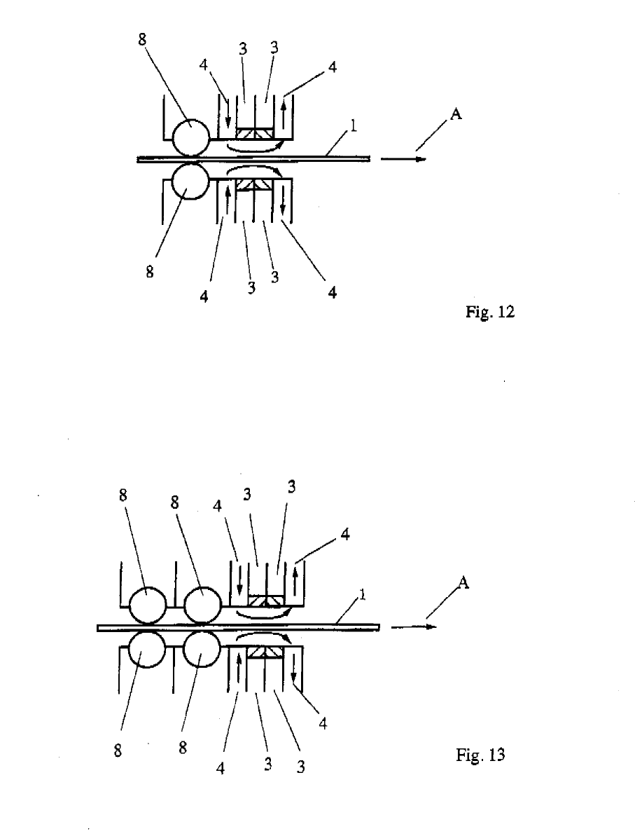

FIGS. 12 and 13 show embodiments in which the device according to the invention works together with conventional squeeze rollers 8. The squeeze rollers 8 are arranged upstream of the air stream guide 4 of the device according to the invention in the strip running direction A. In this way, a first part of the liquid to be removed can already be removed from the strip by the squeeze rollers 8, while the remaining rest of the liquid is removed from the strip by the device according to the invention.

1.-13. (canceled)

14. A method for removing a liquid from the surface of a strip, comprising the step of exciting the liquid in such a way that it oscillates.

15. The method of claim 14, wherein the liquid is excited to oscillate at one of its resonant frequencies.

16. The method of claim 14, wherein the exciting step includes the step of flowing a fluid stream over the liquid as a carrier medium to impart an excitation oscillation for exciting the liquid.

17. The method of claim 16, wherein the fluid stream flows over the liquid in a laminar form.

18. The method of claim 14, wherein the liquid is excited by an oscillating motion of the strip.

19. The method of claim 14, wherein the exciting step for causing the liquid to oscillate is realized directly or indirectly by a contactless excitation method.

20. The method of claim 14, further comprising the step of evaporating the liquid using a sonoluminescence effect.

21. The method of claim 14, wherein a removal of the liquid is performed as the strip moves.

22. A method for removing a liquid from the surface of a strip, comprising the step of evaporating the liquid using a sonoluminescence effect.

23. The method of claim 22, further comprising the step of passing a laminar fluid stream over the liquid.

24. The method of claim 22, wherein a removal of the liquid is performed as the strip moves.

25. A method for removing a liquid from the surface of a strip, comprising the step of passing a laminar fluid stream over the liquid.

26. The method of claim 25, wherein a removal of the liquid is performed as the strip moves.

27. A device for removing a liquid from the surface of a strip, comprising an oscillation generator to excite oscillations in the liquid or in a fluid or body contacting the liquid.

28. The device of claim 27, further comprising a blowing nozzle for supply of the fluid, and a sound-wave generator to introduce sound waves into the fluid supplied by the blowing nozzle.

29. The device of claim 28, wherein the sound-wave generator is constructed to introduce sound waves into the strip.

30. The device of claim 27, further comprising a sound-wave generator to introduce sound waves into the strip.

31. The device of claim 28, wherein the sound-wave generator is a member selected from the group consisting of a loudspeaker, a piezoelectric sound transducer, a magnetic ultrasound generator, an EMAT, and a laser for laser-induced ultrasound.

32. The device of claim 30, wherein the sound-wave generator is a member selected from the group consisting of a loudspeaker, a piezoelectric sound transducer, a magnetic ultrasound generator, an EMAT, and a laser for laser-induced ultrasound.
